(19) United States
(12) Patent Application Publication
(10) Pub. No.: US 2002/0076275 A1
(43) Pub. Date: Jun. 20, 2002

(54) Finger-joint in finger-jointed lumber

(76) Inventors: Roland Hernandez, Monona, WI (US); Dwight D. Flach, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 09/918,918

(22) Filed: Jul. 31, 2001

Related U.S. Application Data
(60) Provisional application No. 60/222,210, filed on Aug. 1, 2000.

(51) Int. Cl. F16B 1/00; F16D 1/00; B25G 3/02

(52) U.S. Cl. 403/364

(57) ABSTRACT

A joint for bonding two wooden segments comprises a staggered finger joint having adjacent tips staggered with respect to one another to define corresponding staggered roots whose voids are configured to accept the staggered tips of a wood segment to be bonded. The resulting stress concentrations at the joint are also staggered, and do not bridge across adjacent fingers.

### CROSS-REFERENCE TO RELATED APPLICATIONS

This application claims priority to provisional U.S. Patent Application No. 60/222,210 filed Aug. 1, 2000 and entitled “Improved Finger-Joint in Finger-Jointed Lumber” the disclosure of which is hereby incorporated by reference as if set forth in its entirety herein.

### BACKGROUND OF THE INVENTION

The present invention relates generally to jointed lumber and, in particular, relates to finger-jointed lumber.

End jointing of lumber to permit the use of single-piece construction began with the use of a scarf-joint design, which arose based on the fact that end-grain bonding of wood has little structural capacity. Accordingly, sloping scarf joints were designed such that the adhesive bond was substantially parallel to the grain of the wood. Although the scarf-joint was structurally efficient, it required large amounts of wood to be removed in order to construct the joint, resulting in a significant loss of resources.

Therefore, referring to FIG. 1, a finger joint 10 was developed, which included cutout portions in the end of the wood segment 12 so as to define a plurality of fingers 14 extending therefrom throughout either the width or the depth of the wood. The fingers defined a pitch, tip thickness, length, and slope, all of which contributing to the overall effectiveness of the joint 10. An adhesive was then used to coat the surfaces of the joint so as to be mated with a corresponding finger-jointed wood segment. The lumber could then be fed through a radio frequency tunnel that exposes the joint to intense frequencies in order to decrease the curing time of the joint. The conventional finger joint 10 is advantageous in that it only requires only approximately 10 percent of the volume of wood to be removed compared to that of a scarf joint.

One significant disadvantage associated with finger jointed lumber is the relatively poor strength characteristics, especially under tensile loading. In particular, such joints have been observed to achieve approximately 45% (for higher grade lumber) to 90% (for lower grade lumber) of the strength of solid lumber having the same grade. The variance between lower and higher grade lumber is explained by the fact that as lumber grade decreases in quality, strength performance begins to be governed by defects in the lumber rather than by the finger joints. The strength of higher grade jointed lumber, therefore, is primarily dependent on the strength of the joint. The low strength associated with high grade lumber joined using a conventional finger joint has resulted in an undesirably high frequency of premature joint failure during tensile loading.

What is therefore needed is a stronger and more reliable joint for connecting two wood segments to reduce premature failure.

### SUMMARY OF THE INVENTION

The present invention recognizes that the poor strength characteristics associated with conventional finger joints reside in the resulting stress concentrations that bridge across adjacent fingers. Accordingly, an improved finger joint is presented that avoids the bridging of adjacent stress concentrations.

In accordance with one aspect of the invention, a staggered finger joint formed within a surface of a first wood segment for adjoinment with a second wood segment. The joint comprises a plurality of adjacent members projecting outwardly from the wood segment and having a plurality of outer and inner tips staggered with respect to one another by a predetermined distance, and corresponding staggered roots disposed between the members that define voids configured to receive staggered members of the second wood segment.

These and other aspects of the invention are not intended to define the scope of the invention for which purpose claims are provided. In the following description, reference is made to the accompanying drawings, which form a part hereof, and in which there is shown by way of illustration, and not limitation, a preferred embodiment of the invention. Such embodiment does not define the scope of the invention and reference must be made therefore to the claims for this purpose.

### BRIEF DESCRIPTION OF THE DRAWINGS

Reference is hereby made to the following figures in which like reference numerals correspond to like elements throughout, and in which:

FIG. 1 is a sectional side elevation view of a conventional finger joint;

FIG. 2 is a schematic illustration of bridged stress concentrations associated with the finger joint illustrated in FIG. 1 showing the region having a strain level of 105% and higher of the far-field strain;

FIG. 3 is a sectional side elevation view of the joint illustrated in FIG. 1 noting typical dimensions associated therewith;

FIG. 4 is a sectional side elevation view of a composite structure formed from two wood segments joined via a staggered finger joint constructed in accordance with the preferred embodiment;

FIG. 5 is a sectional side elevation view of the staggered finger joint illustrated in FIG. 4 noting typical dimensions associated therewith; and

FIG. 6A is a schematic illustration of the resulting stress concentrations associated with the staggered finger joint illustrated in FIG. 4 showing the region having a strain level of 105% and higher of the far-field strain;

FIG. 6B is a schematic illustration of bridged stress concentrations produced using a staggered finger joint with an insufficient amount of stagger showing the region having a strain level of 105% and higher of the far-field strain;

FIG. 6C is a schematic illustration of bridged stress concentrations produced having an excessive degree of stagger showing the region having a strain level of 105% and higher of the far-field strain;

FIG. 7 is a chart plotting finger slope vs. stagger amount for fingers having varying tip widths; and

FIG. 8 is a schematic illustration of a finite element analysis used to determine the results illustrated in FIG. 7.

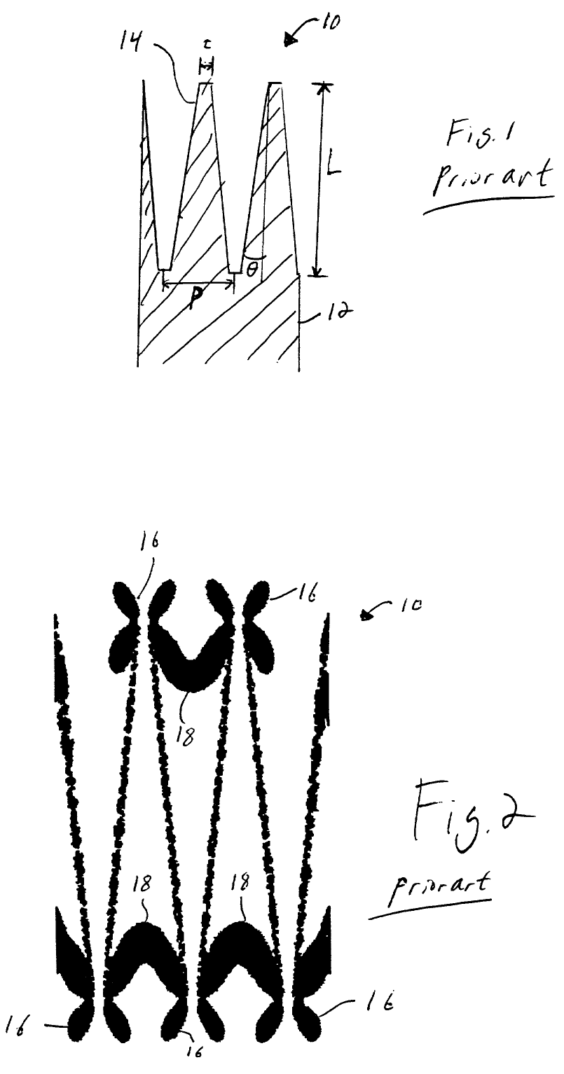

### BRIEF DESCRIPTION OF THE INVENTION

Referring to FIG. 2, it has been recognized that the relatively low strength associated with conventional finger-joint configurations is the result of undesirable stress concentrations 16 within the joint 10 when the jointed lumber is subjected to a tensile stress. This results in a relatively high frequency of premature failure of the joint 10, particularly where high quality lumber grades are being joined. In particular, the present inventors have determined that the low strength associated with conventional finger jointed lumber resides in the properties of the stress concentrations 16 that are disposed proximal the tip of each finger 14. For example, as illustrated in FIG. 2, the low strength results from the bridges 18 that span between the “butterfly shaped” stress concentrations 16, which are illustrated to be that region at the joint having a strain level of 105% (or greater) of the far-field strain, though the present invention does not intend to limit the definition of a stress concentration to 105% or greater of the far-field strain. Furthermore, the size of the bridges 16 increase, thereby further decreasing the strength of the joint 10, during periods of increased tensile loading. As a result, it has been found that approximately 75% of conventional finger jointed lumber fails at a location proximal the tips of the joint.

The preferred embodiment of the invention improves upon conventional structural finger-joint designs, particularly suitable for manufacturing glued-laminated timber, by eliminating the bridge 16 that exists between adjacent stress concentrations 16 in conventional finger joints 10. The improved joint may be fabricated on any suitable surface of lumber, as will now be described.

In particular, referring now to FIG. 4, a staggered finger joint 20 connects a first and second wood segment, 21 and 23, respectively, to form an end jointed composite wooden structure 22 in accordance with the preferred embodiment. Describing the joint with reference to wood segment 21, the joint 20 includes a plurality of fingers 25 and 27 that project outwardly from the wood segment. In particular, a plurality of longer fingers 25 have outer tips 24 interposed between a corresponding plurality shorter fingers 27 having inner tips 26 that are recessed (staggered) from the outer tips 24 by a predetermined amount. The tips extend generally perpendicular with respect to the axis of extension of wood segment 21. Each of the longer fingers 25 and shorter fingers 27, respectively, project an equal distance outwardly from wood segment 21 so as to provide uniformity to the joint 20 to facilitate its meshing with other finger jointed wood segments, such as segment 23.

A corresponding plurality of inner and outer roots 28 and 30, respectively, is disposed between the fingers 26 and 27, and collectively define a plurality of voids 32 and 34 that are configured to receive the tips of a wood segment to be joined. In particular, smaller voids 32 are formed in the first wood segment 21 that is sized to receive the inner tips of the second wood segment 23 that is to be joined, while larger voids 34 are formed to receive the outer tips of wood segment 23. Accordingly, the stagger between adjacent roots 28 and 30 is the same as the stagger between adjacent tips 24 and 26. It should be appreciated that the terms “outer” and “inner” are made with respect to the wood segment 21 in which the joint 20 is disposed, rather than the joint itself.

Walls having three different sizes are used to construct the finger joint 20 in accordance with the preferred embodiment: a shorter wall 36, a mid-sized wall 38, and a longer wall 40, it being appreciated that these size designations are described as relative to the other walls. The longer fingers 25 are defined by a longer wall 40 that extends outwardly from inner root 28 and is connected to the outer tip 24 which, in turn, is connected to a mid-sized wall 38. The smaller voids 32 are defined by the mid-sized wall 38 that is connected to the outer root 30 which, in turn, is connected to shorter wall 36. The shorter fingers 27 are defined by the shorter wall 36 that extends outwardly from outer root 30 and is connected to inner tip 26 which, in turn, is connected to mid-size wall 38. connected to tip 26 which in turn is connected to a mid-sized wall 38. The larger voids are defined by the mid-sized wall 38 connected to inner root 28 which, in turn, is connected to the longer wall 40.

The corresponding wood segment 23 that is to be joined also includes a plurality of inner and outer tips and roots, offset from those disposed on wood segment 21 by a distance equal to the distance between an adjacent tip and root. Accordingly, the two wood segments 21 and 23 intermesh, with the outer tips 24 interfacing the inner roots 28, and the inner tips 26 interfacing the outer roots 30. An adhesive is applied to the outer surface of the joint 20 prior to connecting the two wood segments. The composite structure 22 could then be fed through a radio frequency tunnel to expose the joint 20 to intense frequencies so as to decrease the curing time of the joint 20.

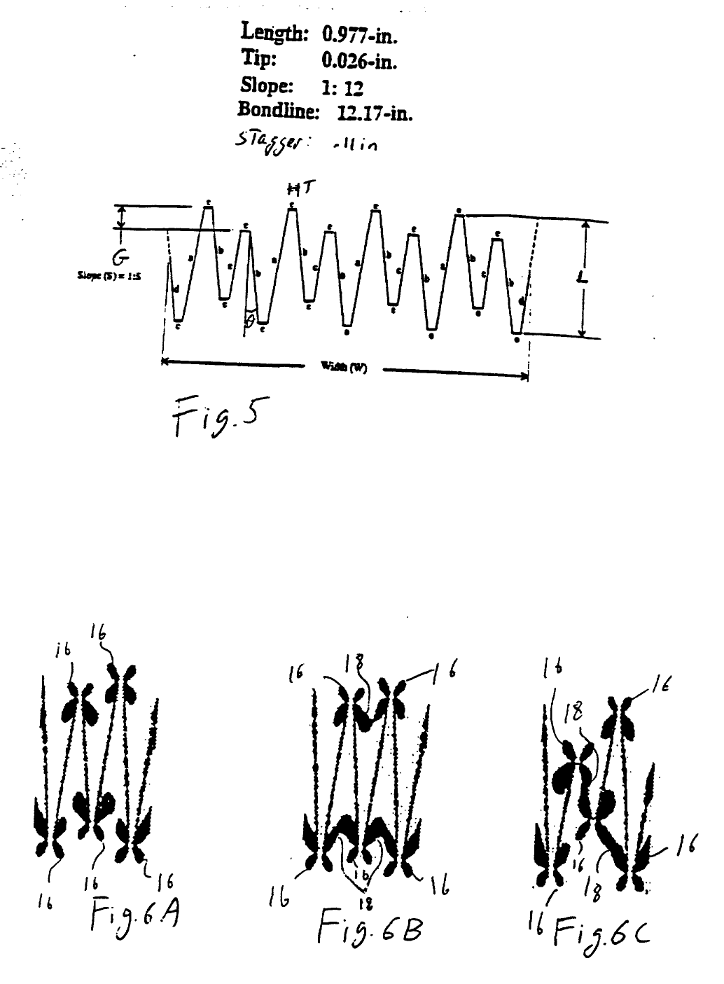

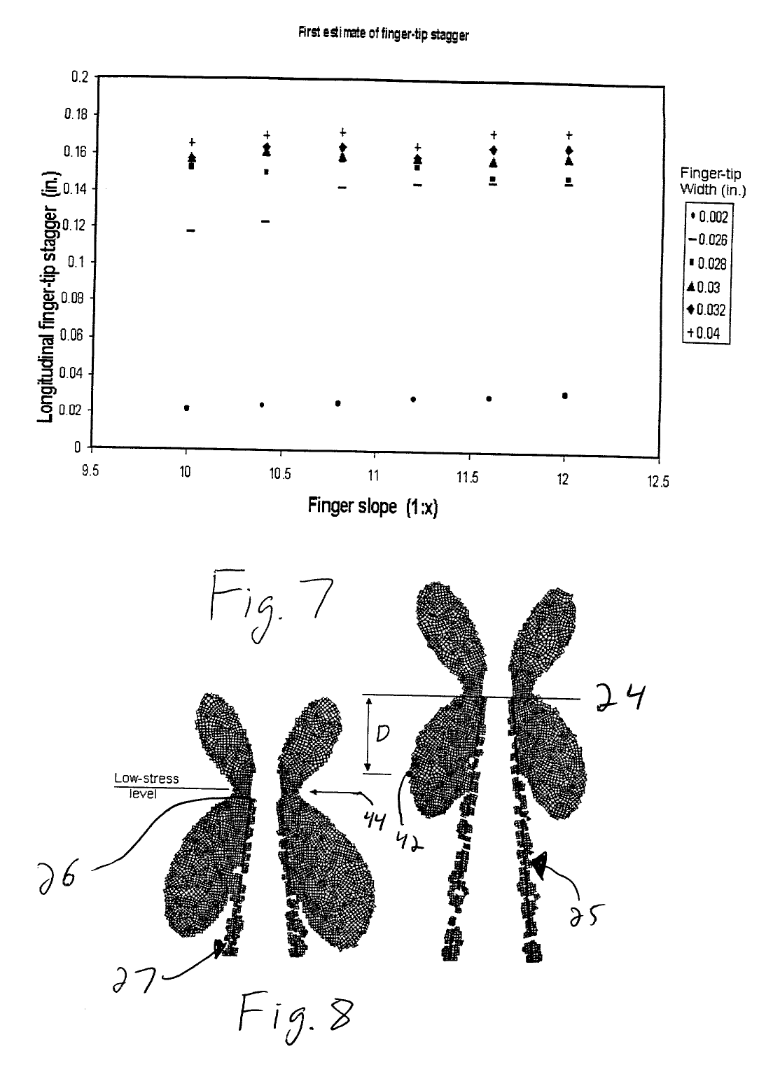

Referring now also to FIG. 6A, the staggered finger joint 20 correspondingly produces corresponding staggered stress concentrations 16, whose distance between adjacent stress concentrations is increased compared to those produced in when using conventional finger joints. As a result, the stress concentrations 16 are bridge-free, and thus isolated. While merely increasing the lateral distance between fingers 14 of a conventional joint 10 would also remove the bridge 18, doing so would also decrease the bond line, which would weaken the resulting joint. As will be described in more detail below, the staggered finger joint 20 increases the bond line compared to conventional finger joints 10, thus strengthening the joint not only due to the elimination of bridges 18, but also due to the increased bond line.

Referring now to FIG. 6B, it should be appreciated that the stress concentrations 16 could still bridge if, for example, the degree of stagger between adjacent fingers is insufficient. In this case, the bridge would exist across stress concentrations corresponding to adjacent tips 24 and 26. Alternatively, the bridge 18 may join adjacent stress 16 concentrations if the stagger is too great, as illustrated in FIG. 6C. In this case, the bridge 18 would join adjacent stress concentrations 16 that are associated with adjacent intermeshing inner tips 26 of the two wood segments 21 and 23.

One example of a staggered finger joint 20 constructed in accordance with the present invention has dimensions sufficient to avoid the bridges 18 between adjacent stress concentrations 16 without adversely affecting the bond line, as will now be described with reference to FIG. 5. It should be appreciated that while the illustrated configuration is effective in eliminating the bridge 18, it is merely one example of many possible finger joint configurations. Accordingly, any joint for bonding two or more wood segments having staggered fingers that achieves an increase in strength over conventional non-staggered finger joint is intended to fall under the scope of the present invention, as defined by the appended claims.

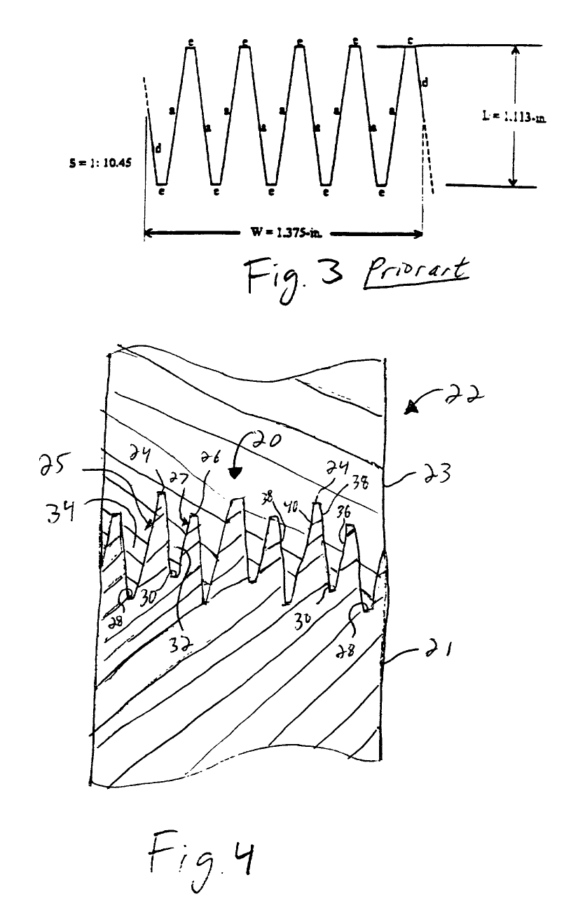

As will now be described, the staggered finger joint 20 increases the bond line associated with the joint when compared with traditional finger joints. In particular, referring to FIGS. 3 and 5, the conventional and staggered finger joints are formed in a wood segment having a width (W). The joints includes a tip width (T), a length (L) spanning from outer tip-to-outer tip, a pitch (P) defined as the distance between adjacent roots, and an angle (θ) defined with respect to the wall and the vertical direction. The slope (S) of the walls is defined by Tan θ. The staggered finger joint also has a stagger (G), defined as the distance between the outer and inner tips 24 and 26, respectively, and also the outer and inner roots 30 and 28, respectively. It has been observed that stronger bonds exist between two pieces of lumber by reducing T and S, and by increasing L to correspondingly increase the bond line of the joint. However, a tradeoff exists between increasing L and removing unnecessarily large amounts of lumber. Conventional finger joints disposed in a 1.375 in. wide wood segment have been measured to have a length of 1.113 in., a tip of between 0.030-0.032 in., a slope of 1:10.45, and a resulting bond line of 11.18 in., as will be described in more detail below.

In accordance with illustrated embodiment, the fingers are staggered with respect to one another by 0.11 inches. The tips and roots are 0.026 inches wide, the slope of the walls connecting tips to roots is 1:12, and the length from outermost tip to outermost root is 0.977 inches. Those having ordinary skill in the art recognize that the tip width and slope are less than those associated with conventional finger joints. Additionally, while the length in accordance with the preferred embodiment is less than that of conventional finger joints, the bond line is nonetheless increased comparatively across a 1.375 in. wide segment of lumber, as will now be demonstrated.

With continuing reference to FIG. 5, the horizontal distance components associated with the segments a-d of the staggered finger joint having a slope S in the form of 1:S, a stagger G, a width W, a length L, are defined as:

a=L/S; b=(L−G)/S; c=(L−2G)/S, d=(L/2)/S; and e=T. (1)

The width W is the summation of the horizontal components of the segments, or

W=4a+8b+4c+2d+17e. (2)

Otherwise stated,

W=4L/S+8(L−G)/S+4(L−2G)/S+2(L/2)/S+17(T). (3)

Equation (3) reduces to

W=17L/S−16G/S+17(T). (4)

Accordingly,

L=SW/17+16G/17−S(tip). (5)

In order to calculate the total length of the bond line, the Pythagorean theorem produces the following equations:

$$\begin{matrix}[ 0041 ] ( 6 ) {a}_{s} = \sqrt{{( \frac{L}{S} )}^{2} + {L}^{2}} \\ [ 0042 ] ( 7 ) {b}_{s} = \sqrt{{( \frac{L - G}{S} )}^{2} + {( L - G )}^{2}} \\ [ 0043 ] ( 8 ) {c}_{s} = \sqrt{{( \frac{L - 2 G}{S} )}^{2} + {( L - 2 G )}^{2}} \\ [ 0044 ] ( 9 ) {d}_{s} = \sqrt{{( \frac{L / 2}{S} )}^{2} + {( L / 2 )}^{2}}\end{matrix}$$

The total length (Dₛ) of the bond line is the summation of the total lengths of these segments, and is expressed as:

Dₛ=4aₛ+8bₛ+4cₛ+2dₛ. (10)

When W=1.375, S=1:10.45, and L=1.113, and the stagger is 0.11 in., the total length of the resulting bond line is 17.4 inches, significantly greater than the bond line produced using a conventional finger joint, as will be described in more detail below.

Examples of various values for the bond line length (Dₛ) and joint length (L) are set forth below in Table 1 for a segment wood having a width W of 1.375 in, a stagger of 0.1 in, and a tip of 0.026 in.

TABLE 1

| | | | | | Bond line | | | | |
|---|---|---|---|---|---|---|---|---|---|
| Width (W) | Tp | Slope (S) | Stagger (G) | Length (L) | length (Ds) | As | Bs | Cs | Ds |
| 1.375 | 0.026 | 10.5 | 0.1 | 0.670 | 9.841 | 0.673 | 0.573 | 0.473 | 0.337 |
| 1.375 | 0.026 | 10.6 | 0.1 | 0.676 | 9.934 | 0.679 | 0.578 | 0.478 | 0.339 |
| 1.375 | 0.026 | 10.7 | 0.1 | 0.681 | 10.027 | 0.684 | 0.584 | 0.483 | 0.342 |
| 1.375 | 0.026 | 10.8 | 0.1 | 0.687 | 10.120 | 0.690 | 0.589 | 0.489 | 0.345 |
| 1.375 | 0.026 | 10.9 | 0.1 | 0.682 | 10.212 | 0.685 | 0.585 | 0.494 | 0.348 |
| 1.375 | 0.026 | 11.0 | 0.1 | 0.696 | 10.305 | 0.701 | 0.600 | 0.500 | 0.350 |
| 1.375 | 0.026 | 11.1 | 0.1 | 0.703 | 10.396 | 0.706 | 0.606 | 0.505 | 0.353 |
| 1.375 | 0.026 | 11.2 | 0.1 | 0.709 | 10.481 | 0.712 | 0.611 | 0.511 | 0.356 |
| 1.375 | 0.026 | 11.3 | 0.1 | 0.714 | 10.584 | 0.717 | 0.617 | 0.516 | 0.359 |
| 1.375 | 0.026 | 11.4 | 0.1 | 0.720 | 10.677 | 0.723 | 0.622 | 0.522 | 0.361 |
| 1.375 | 0.026 | 11.5 | 0.1 | 0.725 | 10.770 | 0.728 | 0.628 | 0.527 | 0.364 |
| 1.375 | 0.026 | 11.6 | 0.1 | 0.731 | 10.963 | 0.733 | 0.633 | 0.533 | 0.367 |
| 1.375 | 0.026 | 11.7 | 0.1 | 0.736 | 10.966 | 0.739 | 0.639 | 0.538 | 0.369 |
| 1.375 | 0.026 | 11.8 | 0.1 | 0.742 | 11.049 | 0.744 | 0.644 | 0.544 | 0.372 |
| 1.375 | 0.026 | 11.9 | 0.1 | 0.747 | 11.142 | 0.750 | 0.649 | 0.548 | 0.375 |
| 1.375 | 0.026 | 12.0 | 0.1 | 0.753 | 11.240 | 0.755 | 0.655 | 0.555 | 0.378 |

It has been determined that smaller tip widths reduce the high stress regions when the lumber is under a tensile loading. Therefore, as the tip width is increased, the length may also be increased, or alternatively the amount of stagger may be increased so that the high stress regions do not overlap. Alternatively, the slope could be increased, but doing so while keeping all other parameters constant could adversely affect the strength of the joint.

The dimensions of the joint may therefore be optimized according to the above equations, which allow for various dimensions associated with a finger joint in accordance with the present invention. Accordingly, the present invention is not to be limited to the examples described above.

To determine the total bond length for a conventional finger joint, the following equations are presented with reference to FIG. 3:

a=L/S; d=(L/2)/S; and e=T. (11)

The width of the wood segment is defined as

W=9a+2d+10e. (12)

Otherwise stated,

W=9L/S+2(L/2)/S+10(T). (13)

Equation 13 further reduces to

W=10L/S+/10(T). (14)

Accordingly,

L=SW/10-S(T). (15)

Using the Pythagorean theorem to solve for the distance of each segment of the bond line:

$$\begin{matrix}[ 0057 ] ( 16 ) {a}_{s} = \sqrt{{( \frac{L}{S} )}^{2} + {L}^{2}} \\ [ 0058 ] ( 17 ) {d}_{s} = \sqrt{{( \frac{L / 2}{S} )}^{2} + {( L / 2 )}^{2}}\end{matrix}$$

The total length of the bond line (Dₛ) for the conventional finger joint is thus

Ds=9 aₛ+2 dₛ. (18)

When L=1.113 in., and S=1:10.45, and W=1.375, the total length of the bond line produced is 11.18 in. Accordingly, even with a smaller length, the staggered finger joint produces a bond line greater than that associated with a conventional finger joint. The increased bond line, coupled with the elimination of bridged stress concentrations, produces a joint that is stronger and more reliable than conventional joints.

Referring now to FIG. 7, it has been determined that the size of the stress concentrations 16, and thus the probability of bridging, is dictated largely by the width of tips 24 and 26, and additionally by the slope of the fingers 25 and 27. Finger tips associated with conventional finger joints are fabricated to a width of 0.030 or 0.032 inches, and are designed to fit within a 1⅜″ to 1½″ thickness of lumber. It is envisioned, however, that staggered finger tip widths could range from 0.002 inches through 0.04 inches, and possibly even beyond. An optimized arrangement for some of these widths has been determined based on the amount of stagger and slope using finite element analysis. It is illustrated that, generally, a less amount of stagger is needed to produce bridge-free stress concentrations for staggered fingers having decreasing tip widths.

At a slope of 1:10, a staggered finger joint having a tip width of 0.002 inches corresponds to a stagger of approximately 0.02 inches. At a slope of 1:12, a staggered finger joint having a tip width of 0.04 inches corresponds to a stagger of approximately 0.18 inches to avoid bridged stress concentrations. Accordingly, the present invention envisions fabricating fingers having tips that are staggered by an amount between approximately 0.02 inches and 0.18 inches. Furthermore, it is envisioned that the slopes of the staggered fingers will be between approximately 1:10 and 1:12.

It should be appreciated that the values illustrated in FIG. 7 are initial approximations using finite element analysis obtained by (1) producing a stress concentration associated with a finger, (2) matching the outermost point 42 on the lower lobe of the stress concentration associated with the longer finger 25 with the low-stress region 44 of the adjacent concentration (indicated by Arrow A), and (3) measuring the initial stagger D. It should be appreciated that while stagger is defined as the longitudinal distance between adjacent tips in accordance with the preferred embodiment, the initial stagger D was initially determined as the distance between the outer tip 24 of longer finger and point 42 using finite element analysis. Once the joint has been optimized, as described below, the final stagger (tip-to-tip) may be calculated.

The results of the initial finite element analysis approximations illustrated in Table 2 below (including the initial stagger) are described herein to provide a range of tip widths, stagger amounts, and slopes that are currently envisioned. It should be appreciated, however, that any joint having staggered fingers whose slope, stagger amount, and tip width falls outside of the results illustrated is also intended to fall within the scope of the present invention.

TABLE 2
Stagger in view of various tip widths and finger slopes

| | | Finger-tip width (inch) | | | | | |
|---|---|---|---|---|---|---|---|
| | | 0.002 | 0.026 | 0.028 | 0.03 | 0.032 | 0.04 |
| SLOPE | 10 | 0.0213 | 0.1168 | 0.1523 | 0.1578 | 0.157 | 0.1657 |
| | 10.4 | 0.0237 | 0.1231 | 0.1499 | 0.161 | 0.1637 | 0.1702 |
| | 10.8 | 0.0253 | 0.142 | 0.157 | 0.1594 | 0.1641 | 0.1723 |
| | 11.2 | 0.0284 | 0.1444 | 0.1539 | 0.1586 | 0.1586 | 0.165 |
| | 11.6 | 0.0292 | 0.1452 | 0.1483 | 0.1578 | 0.1643 | 0.1726 |
| | 12 | 0.0316 | 0.1452 | 0.1483 | 0.1594 | 0.1648 | 0.1733 |

If desired, additional iterations may be performed to optimize the joint by determining the minimal amount of stagger necessary for a given joint to produce unbridged adjacent stress concentrations for a 105% stress region. Accordingly, the location of point 42 may change with each iteration. After each iteration, the joint maybe analyzed using equations (1) -(10) to ensure the joint has a proper geometric configuration given the thickness of the lumber in which the joint is to be disposed. For example, referring now also to FIG. 5, an optimization of a joint having a slope of 1:12 and a tip of 0.026 inches yields a stagger of 0.11 inches, which is significantly less than the 0.1452 inches noted in Table 2.

The invention is not intended to be limited to the specific profiles described herein in accordance with the preferred embodiment. Rather, the present invention is intended to encompass all finger joints having staggered fingers that reduce the size of stress concentrations proximal the finger tips associated with conventional non-staggered finger joints. The full scope of the present invention is to be understood with reference to the following claims.

We claim:

1. A staggered finger joint formed within a surface of a first wood segment for adjoinment with a second wood segment, the joint comprising:
a plurality of adjacent members projecting outwardly from the wood segment and having a plurality of outer and inner tips staggered with respect to one another by a predetermined distance, and corresponding voids having staggered roots disposed between the members that are configured to receive staggered members of the second wood segment.

2. The staggered finger joint as recited in claim 1, wherein the plurality of voids includes a first plurality of voids that are longer than a second plurality of voids.

3. The staggered finger joint as recited in claim 1, wherein the members are staggered by an amount substantially between 0.02 inches and 0.18 inches.

4. The staggered finger joint of claim 1, wherein the surface comprises an end of the wood segment.

5. The staggered finger joint of claim 1, wherein the surface comprises an edge of the wood segment.

6. The staggered finger joint as recited in claim 1, wherein a stress concentration is disposed proximal each of the tips, and wherein the stress concentrations do not form a bridge with respect to adjacent stress concentrations at strain levels of 105% of far-field strain.

7. The staggered finger joint as recited in claim 1, wherein the members have a tip width substantially between 0.002 inches and 0.04 inches.

8. The staggered finger joint as recited in claim 1, further comprising an adhesive applied to the members prior to bonding with the second wood segment.

9. A finger joint formed within a surface of a first wood segment for adjoinment with a second wood segment, the finger joint comprising:
a plurality of adjacent fingers projecting outwardly, each finger having a tip that is staggered with respect to an adjacent tip, wherein the staggered fingers define voids therebetween configured to mesh with staggered fingers of the second wood segment.

10. The finger joint as recited in claim 9, wherein each finger is defined by walls having a slope substantially between 1:10 and 1:12.

11. The finger joint as recited in claim 9, wherein each finger has a tip of between 0.002 inches and 0.04 inches.

12. The finger joint as recited in claim 9, wherein each tip is staggered with respect to the adjacent tip by an amount substantially between 0.02 inches and 0.18 inches.
